(19) United States
(12) Patent Application Publication
(10) Pub. No.: US 2019/0014766 A1
(43) Pub. Date: Jan. 17, 2019

(54) FISHING SYSTEM

(71) Applicant: Eric P. Berg, Blaine, MN (US)

(72) Inventor: Eric P. Berg, Blaine, MN (US)

(21) Appl. No.: 16/032,636

(22) Filed: Jul. 11, 2018

Related U.S. Application Data
(60) Provisional application No. 62/531,583, filed on Jul. 12, 2017.

(51) Int. Cl. A01K 91/06; A01K 91/04; A01K 91/047; A01K 91/053; A01K 95/00

(52) U.S. Cl. CPC A01K 91/06; A01K 91/04; A01K 95/00; A01K 91/053; A01K 91/047

(57) ABSTRACT

A fishing system is disclosed. In one aspect, the fishing system includes a first fishing line segment terminating with a hook and a second fishing line segment terminating with a sinker. An attachment point can also be provided, wherein a first eyelet of the attachment point is slidably arranged on the first fishing line segment and a second eyelet of the attachment point is attached to the second fishing line segment. The fishing system can also include an immovable stopper attached to the first fishing line segment and a rigid or non-collapsing flexible tube spaced between the hook and the immovable stopper. In one aspect, the hook, stopper, and tube can move distally away from the first eyelet. The fishing system can also include a spherical ball spacer situated between the stopper and the first eyelet.

### CROSS REFERENCE TO RELATED APPLICATIONS

This application claims the benefit of U.S. Provisional Application No. 62/531,583, filed Jul. 12, 2018, and titled “Fishing System,” the disclosure of which is hereby incorporated herein by reference.

### BACKGROUND

The most important aspect of any fishing system is that the system catches the target fish. An effective fishing system must be designed so that the fisherman's chances of catching fish are maximized. To this end, many types of fish lures, rods, lines, and other terminal tackle have been offered. The term terminal tackle means the combination of lines, swivels, attachments, and hooks that terminate the fishing system. The terminal tackle is the part of the fishing system that is closest to the fish when the system is near or on the bottom of the body of water. Some fish are very aggressive feeders and strike just about any kind of artificial lure or live bait within striking range. Other fish are slow feeders. That means they need to be coaxed to strike a lure or live bait and may not take the bait at all. They are so wary that even when they strike a bait, especially live bait, they may drop it before the fisherman knows he has a strike. Or, even though the fisherman knows the fish has taken the bait, the bait is dropped. Of course, the fisherman can never know for certain why a fish may drop his live bait, but a popular view is that the fish has sensed that the live bait is not natural and should be discarded. Of course, there are many things that can contribute to a hooked live bait being unnatural. The whole idea of using a live bait is to fool the fish into thinking it has captured a real bait. Improper hooks (perhaps too large or an improper design), line that is too easy to see, and too much weight on the line which the fish can somehow sense are just a few variables that can make the bait seem unnatural to the fish and which the fisherman must consider to maximize his chances of catching fish.

There are several methods that are used to try to reduce the chances that the fish will perceive the live bait it has taken is unnatural and thus may be dropped. The most common method used for fishing on or near the bottom of the body of water is what is called a “slip-sinker.” This method consists of a sinker with a tunnel or hole through which the line is threaded. The line is terminated with a desired lure or baited hook. The distance between the baited hook and the sinker can be adjusted by a small split-shot sinker, compressed onto the line, which is too large to slide through the main sinker. This system can be very effective in catching bottom-feeding fish, like a walleye or catfish. However, the bait is always near, or on the bottom, of the lake. As the bait is retrieved, the larger sinker drags along the bottom and can snag bottom debris, mostly rocks and sunken logs. If the sinker (or hook) cannot be loosened, a broken line results and the fisherman must re-rig, wasting valuable fishing time. It is not unusual, using this method, that the bait is dropped before the hook is set. This may be due to the weight of the sinker, attached to the bait the fish has taken, which the fish perceives as unnatural.

A well-known fishing system, which depends upon a release mechanism that engages after a fish strikes, is used by fishermen who troll for their target fish. Fish targeted by this approach are lake trout, salmon, or any aggressively feeding fish species that usually are suspended off the bottom. These fish prefer a fast-moving lure with an erratic or fast-action which simulates a swimming fish or one that is injured. The release mechanism is a metal clip to which the line is wound. The lure follows the clip by several feet, or more, and the clip releases when the lure is taken. This fishing system requires a heavy weight, ten pounds or more, to be attached below the release clip. This weight is required so that the fishing depth can be maintained, while trolling at a speed, usually three miles per hour (mph) or more, which produces an attractive action to the lure. The fishing line, after the strike, is free of the weight and the fisherman can fight the fish without any added weight on the line. The heavy weight remains attached to the outrigger by the wire line. As such, this line can become tangled in the fishing line if it is not re-wound quickly onto the outrigger spool. This approach requires specialized equipment, e.g., an outrigger system, wire line, weighted ball, release clip with an adjustable force setting, and an attached gauge to determine the depth of the trolled downrigger ball. Such a configuration is not something the average fisherman uses, and is usually favored by ardent big-water fishermen and charter boat captains.

### SUMMARY

This disclosure focuses on improvements of the terminal tackle which many fishermen use to catch fish near the bottom of a body of fish-holding water. In one aspect the disclosure, fishing systems are presented that operate to help eliminate bottom snags and that also provide a natural “feel” to the bait after it is taken. In one aspect of the disclosure, fishing systems are presented that can suspend the bait above the lake bottom and that can provide an easily triggered release of the bait with minimal weight attached to the released bait.

In many instances, fishermen use appropriate equipment either to troll their lures, or to fish from their boats or docks. In the later cases, the lures are designed to be retrieved or to remain in essentially one place, waiting for the fish to swim nearby and, hopefully, be attracted to the lure. This disclosure is directed to a fishing system which stays in one place, also called “still fishing.” One advantage of still fishing is that the lure does not get snagged on the bottom. Although if the lure is cast-out and let sink, it can become snagged during the retrieval. Another common method of still fishing is to use a bobber. This requires a sinker near the baited hook to keep the lure at a set distance below the bobber. An obvious problem with bobber fishing is that when the fish takes the lure, it also drags the weight of the bobber with it. This extra weight can alert the fish that the live bait is not natural, which can lead to the fish dropping the bait, as mentioned before. This disclosure is directed to systems that can make still-fishing much more effective than current systems. First, when the fish strikes the live bait, the hook and bait is immediately released by the fisherman and the fish will feel essentially no extra weight on the line. Second, the depth of the lure can be adjusted over a large range with the use of a connected sinker, for example a clip-on sinker or a tied-on sinker. This feature is especially useful if the fish are suspended and not near the bottom of the lake. Fourth, for fairly deep water, the weight of the sinker can be increased significantly so that the bottom is always contacted, which can be felt by the fisherman, and the lure system and release function is essentially identical to that of a shallow water set-up. Another feature of this system is that the live bait can be held out from the main line so that entanglement is avoided. A fisherman can use a fishing system with these advantageous features in several ways. He can simply lower the system until the sinker hits the bottom. He will then maintain a taut line until he feels a strike, even a slight nibble. He can then wait for the fish to start to run with the live bait and give line so the fish has little to no sensation that it is about to be hooked. After a short while, timing depending on the fisherman's preference, the fisherman can slowly pull back on the line, taking up any line slack, and then set the hook. Using this method, the fisherman does not have to fish only in one location, but can move around the sides of the boat or dock to cover more water and increase his chances of a fish seeing his lure.

One exemplary fishing system in accordance with the present disclosure includes a first fishing line segment terminating with a hook and a second fishing line segment terminating with a sinker. An attachment point can also be provided, wherein a first eyelet of the attachment point is slidably arranged on the first fishing line segment and a second eyelet of the attachment point is attached to the second fishing line segment. The fishing system can also include an immoveable stopper attached to the first fishing line segment and a rigid or non-collapsing flexible tube spaced between the hook and the immovable stopper. In one aspect, the hook, stopper, and tube can move distally away from the first eyelet. The fishing system can also include a spherical ball spacer situated between the stopper and the first eyelet.

A variety of additional aspects will be set forth in the description that follows. The aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

FIG. 1 is a side perspective view of a first example prior art fishing system.

FIG. 2 is a side perspective view of a second example prior art fishing system.

FIG. 3 is a side perspective view of a third example prior art fishing system.

FIG. 4 is a side perspective view of the prior art fishing system shown in FIG. 3.

FIG. 5 is a side perspective view of the prior art fishing system shown in FIG. 3, further showing an attached downrigger ball.

FIG. 6 is a side perspective view of the prior art fishing system and downrigger ball shown in FIG. 5, showing additional portions of the downrigger ball.

FIG. 7 is a side perspective view of on exemplary fishing system having features in accordance with the present disclosure, the fishing system being shown in a first position.

FIG. 8 is a side perspective view of the fishing system shown in FIG. 7, the fishing system being shown in a second position.

FIG. 9 is a side perspective view of an exemplary fishing system having features in accordance with the present disclosure.

FIG. 10 is a side perspective view of an exemplary fishing system having features in accordance with the present disclosure.

FIG. 11 is a side perspective view of an exemplary fishing system having features in accordance with the present disclosure.

### DETAILED DESCRIPTION

Various examples will be described in detail with reference to the drawings, wherein like reference numerals represent like parts and assemblies throughout the several views. Reference to various examples does not limit the scope of the claims attached hereto. Additionally, any examples set forth in this specification are not intended to be limiting and merely set forth some of the many possible examples for the appended claims. Referring to the drawings wherein like reference numbers correspond to like or similar components throughout the several figures.

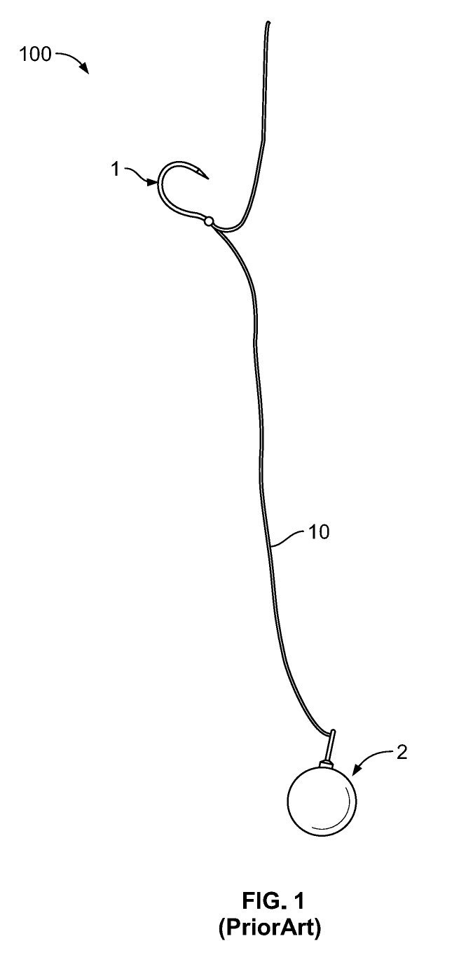

Referring to FIG. 1, a prior art fishing system 100 popular with largemouth bass fishermen, referred to as a “Drop-shot”, is presented. As shown, the fishing system includes a hook 1, a sinker 2, and a line 10. The most distinguishing feature is that the hook 1, instead of being attached to the end of the line 10, is fixedly (i.e. tied) attached to the line 10 a given distance from the end. Also, the sinker 2 is attached at the end of the line. This configuration allows the fisherman to drop the bait straight down from the boat or pier. The depth can easily be felt by the user and the bait can be moved up or down by lifting or lowering the rod tip. The fisherman must be constantly vigilant since this system does not give the fish any time to “run” with the bait. If the fish isn't immediately hooked, the fish may drop the bait because it is still attached to the sinker, which the fish may feel is unnaturally heavy. This system can be effective for aggressive fish, like largemouth bass, when they are located in heavy weeds, letting the fisherman pull the hooked fish directly up to the boat and avoiding having the fish tangle in the weeds, perhaps leading to a lost fish.

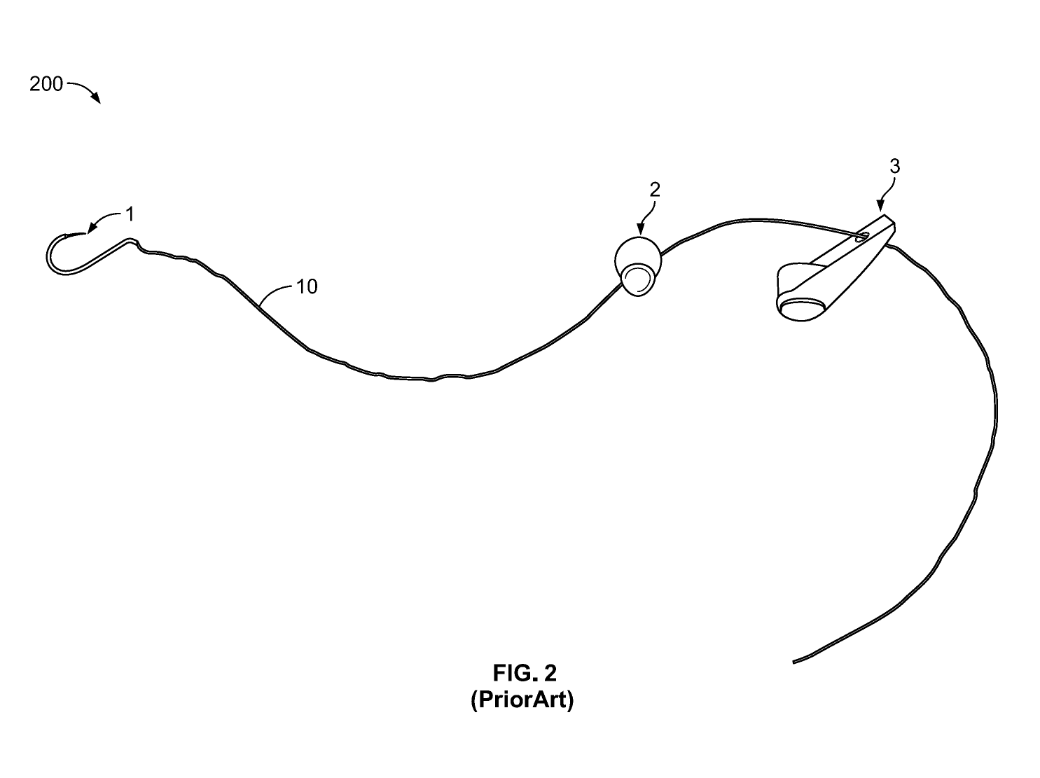

Referring to FIG. 2, a very popular “slip-sinker” prior art fishing system 200 is presented. As shown, the fishing system 200 includes a hook 1, a first sinker 2, a second sinker 3, and a line 10. In one aspect, the hook 1 is provided (i.e. tied) at the end of the line 10. A short distance up the line 10, usually 6 inches to 3 feet, the first sinker 2 (e.g. a split-shot sinker) is provided. Up from the first sinker 2 is the second sinker 3 of larger size with a hole in one end to let the line 10 “slip” through when the fish strikes the lure. The heavier sinker 3 then is left lie on the bottom of the lake and the smaller sinker 2 is dragged along with the hooked fish, hopefully not adding a noticeable amount of weight to alert the fish that struck an unnaturally heavy bait. The disadvantage of this system is that it is usually used to drag the bait along the lake bottom and encounters numerous snags resulting in lost equipment and lost fishing time.

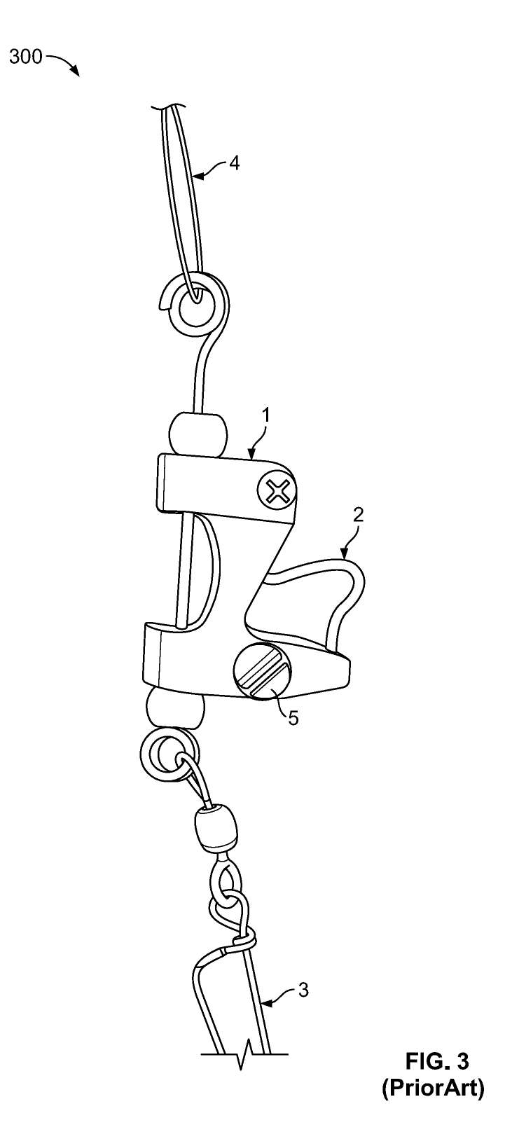

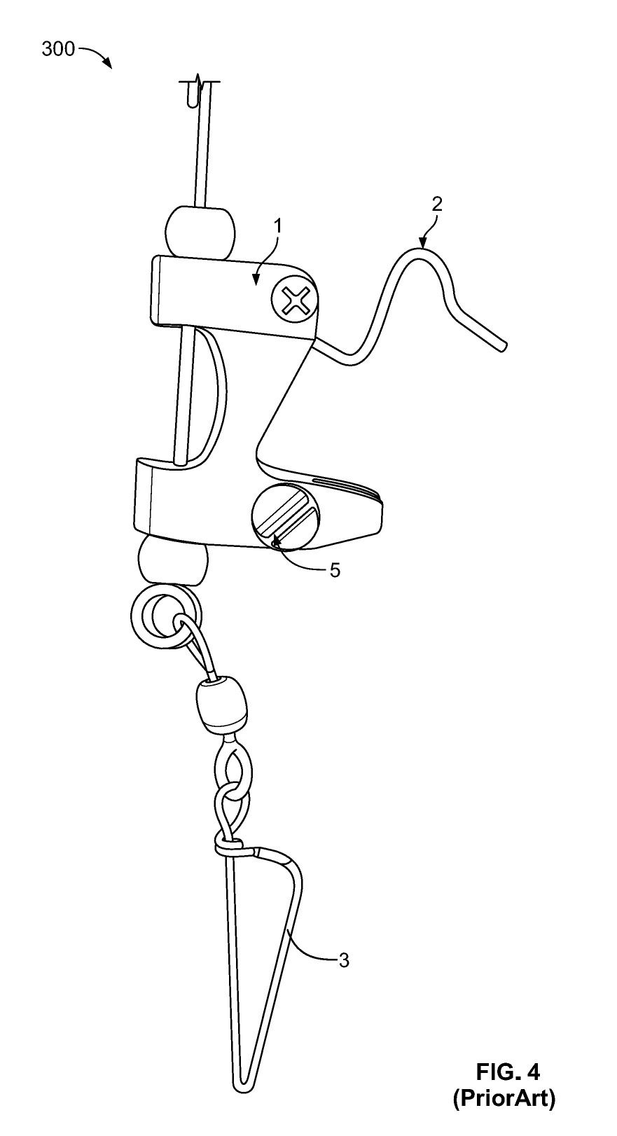

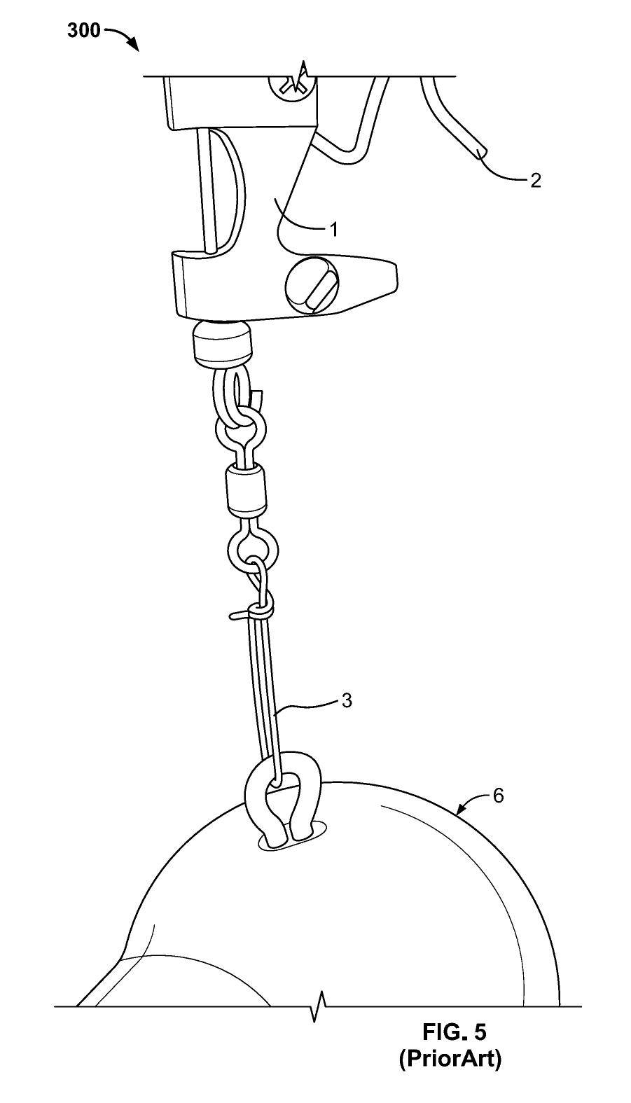

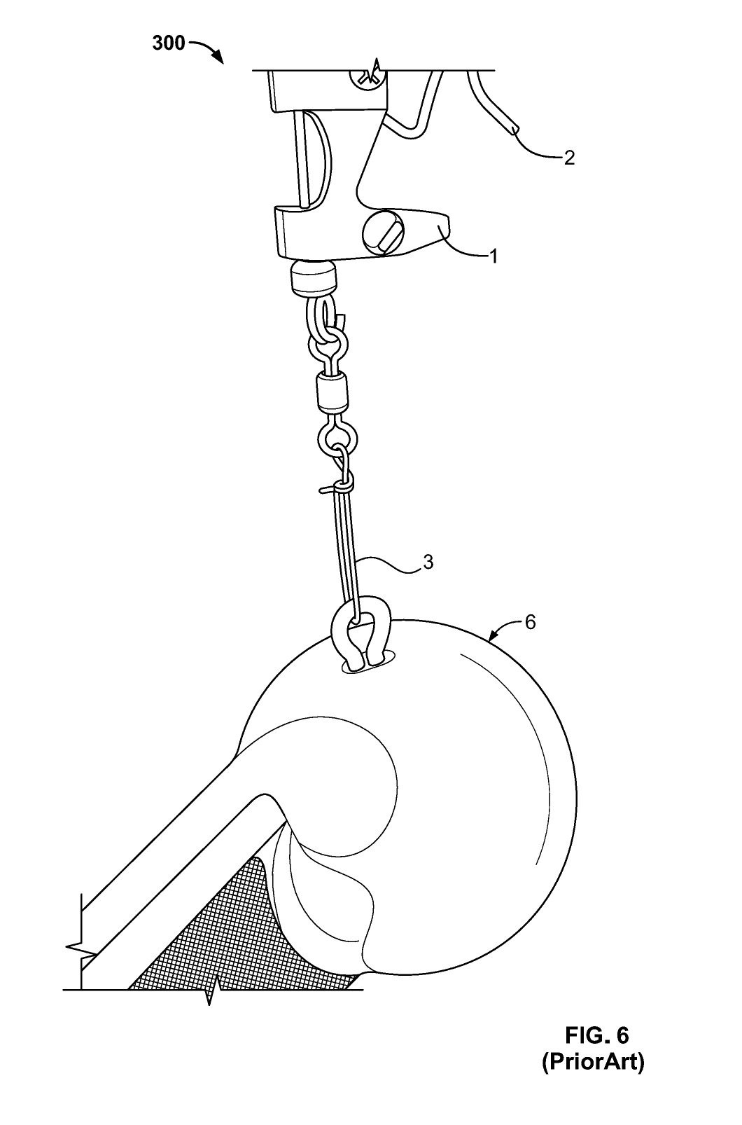

FIGS. 3-6 show a prior art release system 300 which is used with a downrigger. The release system 300 is shown as including a release mechanism 1 including a rotating metal loop 2 and a tension screw 5, a connector 3 connecting the release mechanism 1 to a downrigger ball 6, and a connector 4 connecting the release mechanism to a wire line (not shown). As shown, the release system 300 is attached to a wire line at a clip 4 with the wire line connected to the downrigger spool attached to the gunnel of the boat. The fishing line with the lure is wound around the metal loop 2 and the lure is set back about three feet to give it freedom of movement when it is trolled. A heavy (e.g. 10 lbs) downrigger lead ball 6 is attached to the connector 3. When the fish strikes the lure with sufficient force, the release loop 2, as shown in FIG. 4 opens and the fish can now be reeled-in by the fisherman. This system can only be used with trolling. A disadvantage of this system is that, sometimes the release loop is set too strongly with the tension screw 5, and a smaller fish can be dragged behind the boat without the fisherman noticing it, thereby wasting valuable fishing time. FIGS. 5 and 6 show different perspectives of the heavy downrigger ball 6 attached to the release system 300.

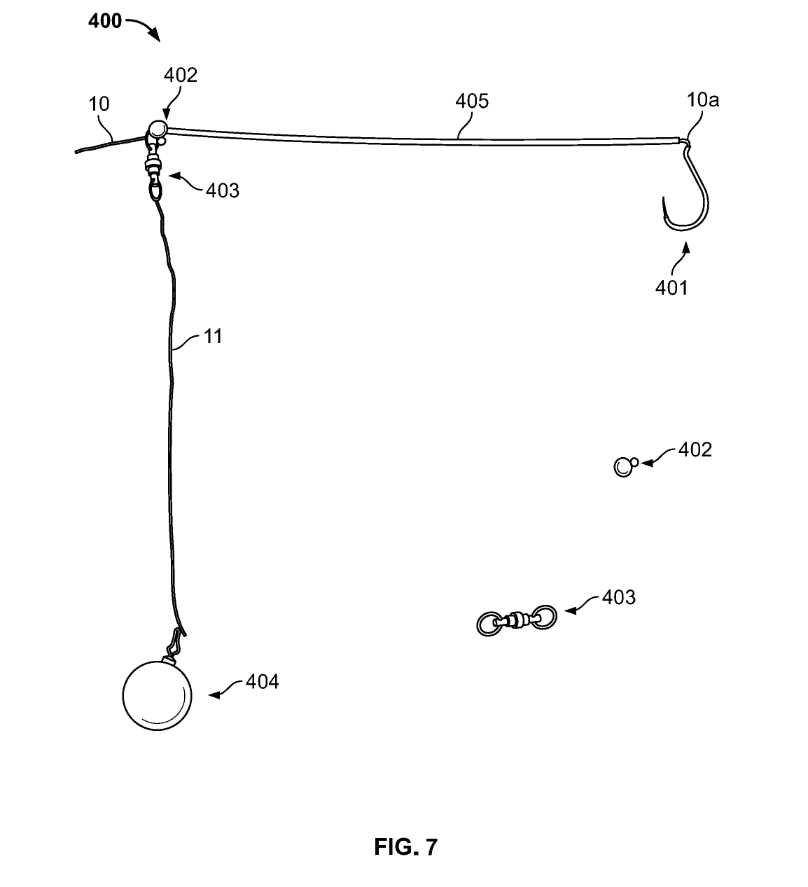

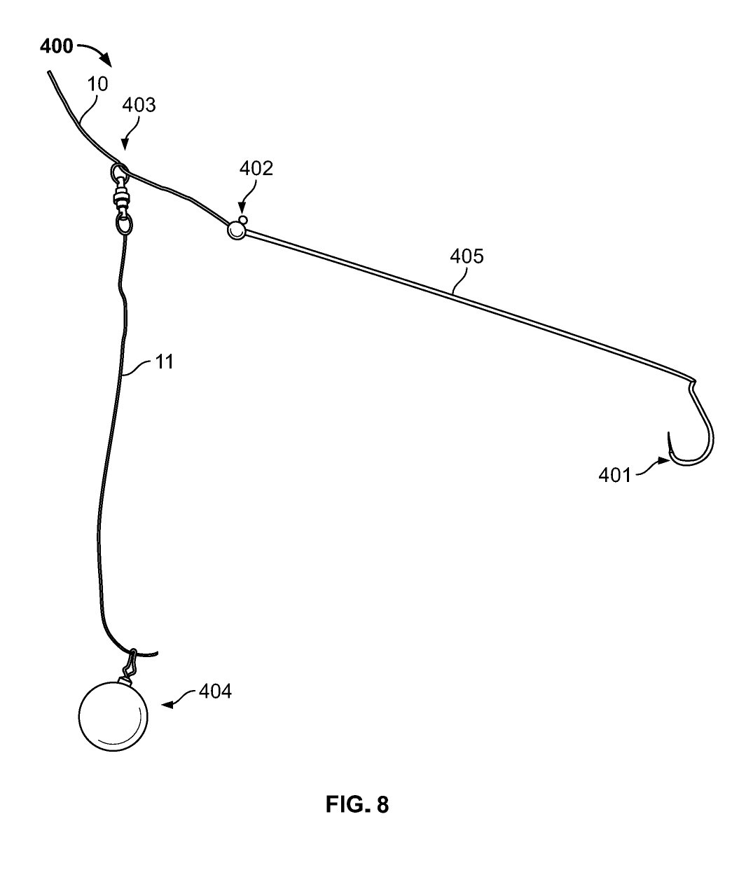

Referring to FIGS. 7 and 8, a fishing system 400 is presented that shows a number of the advantageous elements of the present disclosure. As presented, the fishing system 400 includes a hook 401, a stopper 402, a connector 403, a sinker 404, and a tube 405. The hook 401, which typically is attached to a live-bait, although other baits (e.g. flexible artificial baits) can also be used, can be separated or spaced from the central junction point 403 by the plastic hollow tube 405. This tube 405 can be rigid or somewhat flexible. The main purpose of the tube 405 is to minimize the potential for the bait, especially if it is a live minnow, from entanglement with other parts of the fishing system. In one aspect, the tube 405 is generally the same length as the segment of line 10a extending between the hook 401 and the stopper 402 such that the hook 401 and stopper 402 are generally held at a fixed difference from each other. The sinker 404 is also directly attached to the connector 403, but at a lower location (in orientation shown in drawings). The attachment of the sinker 404 to the fishing line 11 is also fixed. The attachment of the hook 401 and tube assembly 405 is moveable relative to the attachment point 403 and is only held tight against the connector 403 by the fisherman's holding a tight line 10 (i.e. placing tension on the line). The connector 403 has an eyelet that allows the connector 403 to slide along the line 10 and up against the stopper 402. The central attachment point 403 can be a two-eyed swivel connector. The stopper 402 can be provided with any single or combination of effective design elements to immobilize or entangle the line 10 so it cannot be displaced from its position. In one example, the stopper 402 is a double line-wrapped split shot sinker which would operate to cause the stopper 402 to be held in an immovable position on the line 10. Although a squeezed on split shot could be used for stopper 402, it is less preferred as a given amount of force can displace the split shot down the line 10.

In use, the line 10 is released by the fisherman after a bite is recognized, as is shown in FIG. 8, indicating that the hook assembly 401 can be pulled from the connector 403. An important feature of this assembly 400 is that there is placed on the line 10 the immoveable stopper 402 mounted in a fixed relationship with line 10 at a point just adjacent to the elongated tube 405. This stopper allows the retrieval of the fishing system 400 without stressing the tube or hook combination due to the weight of the sinker 404, which can be quite heavy when necessarily used for deeper water.

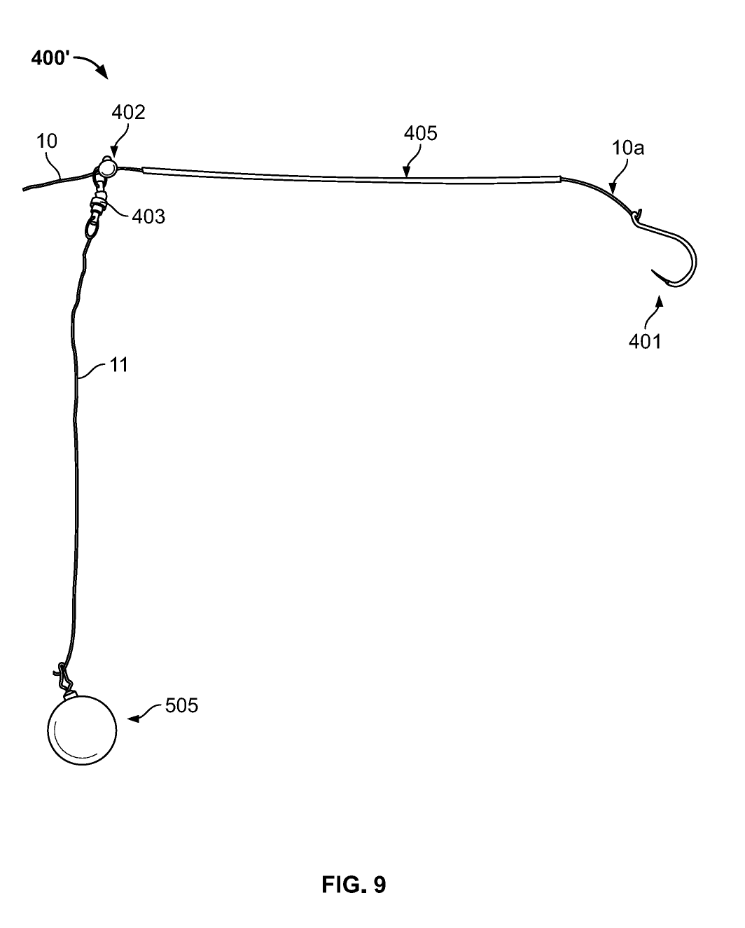

A variation of the fishing system 400 is shown in FIG. 9. The fishing system 400′ shown at FIG. 9 is similar to that shown at FIGS. 7 and 8, but shows the immovable stopper 402, still presented as a double line-wrapped split shot sinker, in an alternate location. As shown, the immoveable stopper 402 is placed slightly up the line 10 from the end of the hollow tube 405, such that more line exists between the hook 401 and stopper 402. This placement allows some hook movement to provide a more realistic bait presentation, as indicated by the small amount of free line 10a shown between the hook 401 and the tube 405. In one aspect, the length of free line 10a between the stopper 402 and the hook 401 is greater than the length of the tube 405.

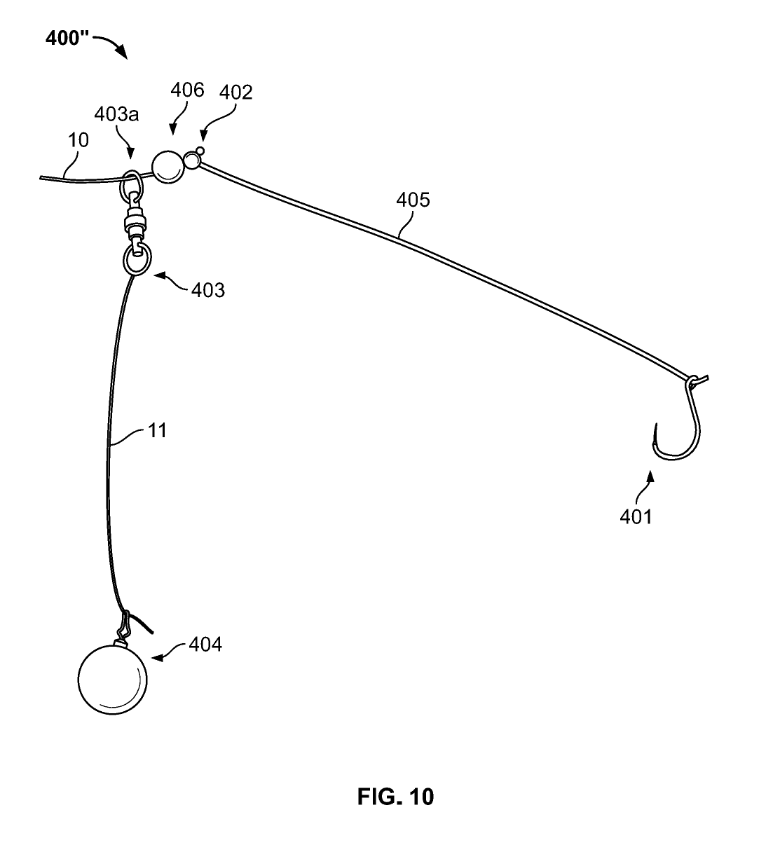

Another variation of the fishing system 400 is shown in FIG. 10. The fishing system 400″ shown at FIG. 10 is similar to that shown at FIGS. 7 and 8, but shows the use of an additional spacer 406. This variation shows that the spacer 406 can be used between the immovable stopper 402 and the connector 403. In this example, the connector 403 is typically a two-eyed swivel connector 403, along with one example of a stopper construction 402, which, in this case, is a double line-wrapped split shot sinker, both of which are similar to the embodiment of FIG. 7. The purpose of the spacer 406, which can be colored, clear, or fluorescent, is to prevent the stopper 402 from sliding up and through the eyelet 403a of the connector 403. This would be required if the eyelet 403a inside diameter is larger than the outside diameter of the stopper 402. It is important to note that the spacer 406 can be made of very light materials, such as plastic foam (which is lighter than water) or hollow plastic or glass balls such that the spacer is buoyant in the water.

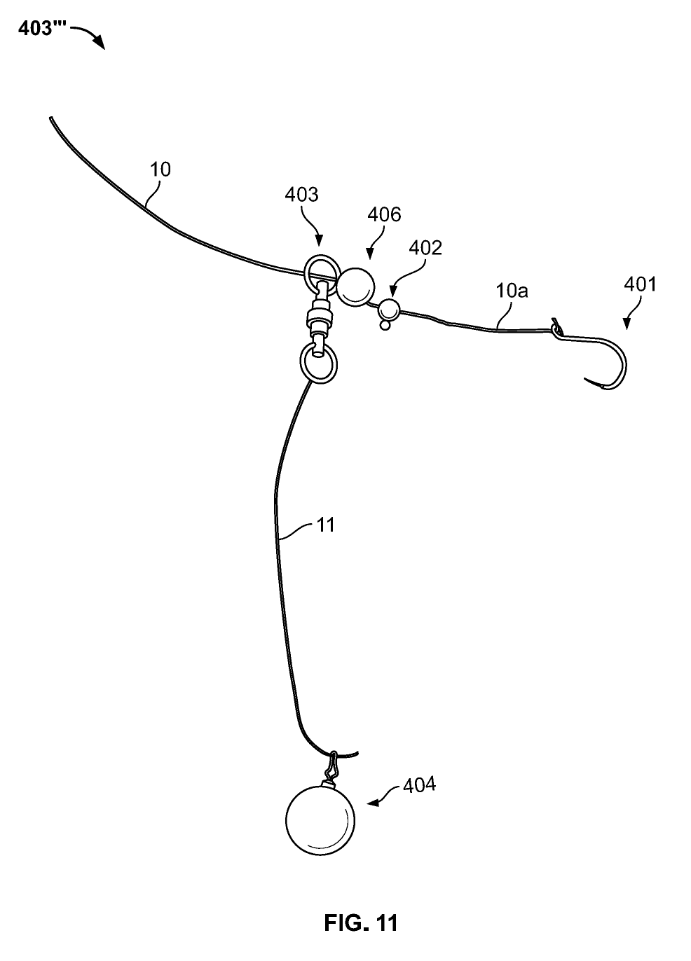

A final variation of the fishing system 400 is very similar to the system 400″ detailed in FIG. 10 and is presented as fishing system 400′″ at FIG. 11. The main difference is the absence of the elongated plastic tube 405 extending from the stopper 402 to the hook eyelet 401. Also, FIG. 11 shows a connector (two-eyed swivel) 403 with fairly large eyes. Here, it is clear that a large diameter spacer ball 406 is necessary to prevent the stopper 402, which is shown as a double line-wrapped split shot sinker, from passing through the eyelet of the connector 403.

From the forgoing detailed description, it will be evident that modifications and variations can be made in the aspects of the disclosure without departing from the spirit or scope of the aspects. While the best modes for carrying out the many aspects of the present teachings have been described in detail, those familiar with the art to which these teachings relate will recognize various alternative aspects for practicing the present teachings that are within the scope of the appended claims.

What is claimed:

1. A fishing system comprising:
a) a first fishing line;
b) a hook attached to the first fishing line;
c) a stopper fixedly connected to the first fishing line at a first distance from the hook;
d) a sinker; and
e) a connector slidably arranged on the first fishing line and fixedly attached to the sinker;
f) wherein the stopper is located between the connector and hook.

2. The system of claim 1, wherein the connector is a two-eyed swivel having a first eyelet slidably arranged on the first fishing line and a second eyelet.

3. The system of claim 2, wherein the second eyelet is connected to the sinker by a second fishing line separate from the first fishing line.

4. The system of claim 3, wherein the first eyelet allows the first fishing line to pass distally through the first eyelet in a first direction and the stopper prevents the first fishing line from passing through the first eyelet in a second opposite direction.

5. The system of claim 4, further comprising:
a) a spherical ball spacer located between the stopper and the connector, wherein an outside diameter of the ball spacer is greater than an inside diameter of the first eyelet.

6. The system of claim 1, further comprising:
a) a hollow tube situated between the hook and the stopper.

7. The system of claim 5, wherein the spacer is buoyant in water.

8. The fishing system of claim 6, wherein the stopper is located on the fishing line between the hook and the central length of the hollow tube is about equal to a distance between the hook and the stopper.

9. A fishing system comprising:
a) a first fishing line segment terminating with a hook;
b) a second fishing line segment terminating with a sinker; and
c) a connector slidably arranged on the first fishing line segment and fixedly attached to the second fishing line segment.

10. The fishing system of claim 9, further comprising:
a) an immoveable stopper attached to the first fishing line segment;
b) a rigid or non-collapsing flexible tube spaced between the hook and the immovable stopper, wherein the hook, stopper, and tube can move distally away from the first eyelet.

11. The fishing system of claim 9, further comprising:
a) a spherical ball spacer situated between the stopper and the first eyelet.

12. The fishing system of claim 9, wherein the connector is a two-eyed connector with a first eyelet slidably arranged on the first fishing line and a second eyelet to which the second fishing line segment is attached.

13. The fishing system of claim 10, where the flexible tube has a length equaling a distance between the hook and immovable stopper.

14. The fishing system of claim 10, wherein a length of the first fishing line segment defined between the stopper and the hook is greater than to length of the flexible tube.

15. A method for making a fishing system, the method comprising:
a) securing a sinker to a connector;
b) feeding a first fishing line segment through a first eyelet of the connector;
c) securing a hook to an end of the first fishing line segment; and
d) securing a stopper to the first fishing line segment at a location between the hook and the first eyelet.

16. The method of claim 15, wherein the step of securing the sinker to the connector includes securing a second fishing line segment to the sinker and to a second eyelet of the connector.

17. The method of claim 15, further including the step of sliding a hollow tube onto the first fishing line segment prior to the step of securing the hook to the first fishing line segment.

18. The method of claim 17, wherein the step of securing the stopper includes butting the stopper to the hollow tube such that a length of the first fishing line segment between the hook and stopper is about equal to a length of the hollow tube.

19. The method of claim 15, further including the step of feeding a spacer onto the first fishing line segment prior to the step of securing the stopper.

20. The method of claim 19, wherein the stopper is buoyant in water.
